(19) United States
(12) Patent Application Publication
(10) Pub. No.: US 2009/0098466 A1
(43) Pub. Date: Apr. 16, 2009

(54) METHOD FOR MANUFACTURING SOLID ELECTROLYTE WITH HIGH ION-CONDUCTIVITY

(76) Inventors: Haruo SAWA, Kochi-shi (JP); Haruyuki Nakanishi, Toyota-shi (JP); Yusuke Kuzushima, Toyota-shi (JP)

Correspondence Address: BERENATO, WHITE & STAVISH, LLC, 6550 ROCK SPRING DRIVE, SUITE 240, BETHESDA, MD, 20817, US

(21) Appl. No.: 12/056,546

(22) Filed: Mar. 27, 2008

(30) Foreign Application Priority Data
Mar. 28, 2007 (JP) 2007-84374

(51) Int. Cl. H01M 6/18

(52) U.S. Cl. 429/307

(57) ABSTRACT

A method for manufacturing a solid electrolyte with high ion-conductivity comprising a hybrid compound of polyvinyl alcohol and a zirconic acid compound which can prohibit gelation of the raw material solution with keeping the concentration of the raw material solution of the solid electrolyte desirable for efficient manufacture of membranes, and provides the solid electrolyte which is inexpensive, and even functions in an alkaline form is disclosed.

The method comprises the steps of hydrolyzing a zirconium salt or an oxyzirconium salt in a solution including a solvent including water, polyvinyl alcohol, and the zirconium salt or the oxyzirconium salt, removing the solvent, and contacting with alkali. The hydrolysis may be carried out by heating to 50° C. or higher or by heating to 50° C. or higher at a pH of 7 or less.

### Field of the Invention

The present invention relates to a method for manufacturing a solid electrolyte with high ion-conductivity of protons (hydrogen ions), hydroxide ions, and the like which is applicable to fuel cells and the like, and which, in particular, can prohibit gelation of the raw material solution with keeping the concentration of the raw material solution of the solid electrolyte desirable for efficient manufacture of membranes, and provides the solid electrolyte which is cheap and even functions in an alkaline form.

### BACKGROUND OF THE INVENTION

Conventionally, electrolytic devices such as fuel cells, dehumidifiers, and electrolytic hydrogen-producing devices have been practically used as electrochemical systems using a proton-conducting solid electrolyte. In particular, the applications of proton-conducting solid electrolytes which operate at room temperature are wide-ranging. For example, in a solid polymer fuel cell, current flows and electric energy are obtained by an electrochemical oxidative reaction of hydrogen supplied to a negative electrode shown by the following formula (1), an electrochemical reductive reaction of oxygen supplied to a positive electrode shown by formula (2), and a reaction based on proton transfer in the electrolyte between the positive electrode and the negative electrode.

H₂→2H⁺+2e⁻ (1)

½ O₂+2H⁺+2e⁻→H₂O (2)

Although there are direct methanol-type fuel cells in which methanol is the fuel supplied to the negative electrode and fuel cells using substances other than hydrogen or methanol as the fuel supplied to the negative electrode, in these cases also, the fuels are electrochemically oxidized at the negative electrode to release protons in a similar manner. Thus, it is possible to operate by using the proton-conductive solid electrolyte.

Electrolytic hydrogen-producing devices, for example, are practically used as electrolytic devices. Electrolytic hydrogen-producing devices produce hydrogen on the basis of a reaction opposite to the reactions in the above-mentioned formulae (1) and (2) in a fuel cell and have the advantage that hydrogen gas is unnecessary since it is possible to obtain high-purity hydrogen on-site by using only water and electric power. Also, by using a solid electrolyte, it is possible to easily carry out electrolysis by the introduction of pure water including no electrolyte. In the paper industry, the on-site manufacture of hydrogen peroxide for bleach by a similar system has been attempted by an electrolytic method using the following formula (3) (refer to Electrochemistry, 69, No. 3, 154 to 159 (2001)).

O₂+H₂O+2e⁻→HO₂⁻+OH⁻ (3)

Dehumidifiers have a structure in which the proton-conducting solid electrolyte film is sandwiched between the positive electrode and the negative electrode, similar to fuel cells or the hydrogen-producing devices. When a voltage is applied between the positive electrode and the negative electrode, water is split into protons and oxygen at the positive electrode by the reaction in the following formula (4). The protons, which have moved through the solid electrolyte to the negative electrode, bind with oxygen in the air to form water again by the reaction of formula (5). As a result of these reactions, dehumidification is carried out at the positive electrode by water moving from the positive electrode to the negative electrode.

H₂O→½O₂+2H⁺+2e⁻ (4)

½O₂+2H⁺+2e⁻→H₂O (5)

It is also possible to split water and to dehumidify by an operation principle similar to electrolytic hydrogen-producing devices. Also, an air conditioner combined with a moisture evaporation cold air device has been proposed (refer to Collected papers of the 2002 National Meeting of the Institute of Electrical Engineers, P3373 (2000)).

Various kinds of sensors, electrochromic devices, and the like are based on an operation principle essentially similar to that mentioned above. It is possible to use a proton-conducting solid electrolyte since these systems operate by the transfer of protons through the electrolyte between two kinds of different redox pairs of positive and negative electrodes. Presently, an experimental study with respect to these systems using proton-conducting solid electrolytes is being carried out.

For hydrogen sensors, for example, the variation of electrode potential dependent on the hydrogen concentration when hydrogen is introduced in the reactions of the above-mentioned formulae (4) and (5) can be used. Furthermore, using the variation of electrode potential or the variation. of ion conductivity, it is also possible to apply to a humidity sensor.

When a substance such as WO₃ is employed as the negative electrode and an electric field is applied to it, the electrochromic device makes a color on the basis of the reaction of the following formula (6) and can be used in display devices and lightproof glass. This system is also operated by donating and accepting protons for the negative electrode, and it is possible to use the proton-conductive solid electrolyte.

WO₃+xH⁺+xe⁻→HxWO₃ (Coloring) (6)

Primary batteries, secondary batteries, optical switches, and electrolyzed water-manufacturing devices can be given as examples of other electrochemical systems which are considered to operate by using a proton-conducting solid electrolyte according to their mechanism. For nickel hydride batteries, as an example of secondary batteries, a hydrogen-absorbing alloy is used as the negative electrode, a nickel hydroxide is used as the positive electrode, and an alkaline electrolytic solution is used as the electrolytic solution. As shown by the following formulae (7) and (8), during charging and discharging, electrochemical reduction and oxidation of the proton occurs at the negative electrode, and hydrogen is stored in the hydrogen-absorbing alloy.

(Charging) H₂O+e⁻→H (Absorbing)+OH⁻ (7)

(Discharging) H (Absorbing)+OH⁻→H₂O+e⁻ (8)

As shown by the following formulae (9) and (10), the electrochemical oxidation and reduction of the nickel hydroxide occurs.

(Charging) Ni(OH)₂+OH⁻→NiOOH+H₂O+e⁻ (9)

(Discharging) NiOOH+H₂O+e⁻→Ni(OH)₂+OH⁻ (10)

The charging and discharging reactions of this battery are conducted by the proton or the hydroxide ion moving in the electrolyte. Although it is possible to use the proton-conducting solid electrolyte according to its mechanism, an alkaline electrolytic solution, which is not a solid electrolyte, is usually conventionally used.

An optical switch using yttrium as the negative electrode has been proposed (refer to J. Electrochem. Soc., Vol. 143, No. 10, 3348 to 3353 (1996)). When an electric field is applied thereto, the yttrium is hydrogenated as shown in the formula (11) to allow light to pass therethrough. As a result, it is possible to switch between transmission and nontransmission of light by the electric field. Although it is possible to use the proton-conductive solid electrolyte in this system, an alkaline electrolytic solution is used in the prior art.

Y+3/2H₂O+3e⁻→YH₃+3OH⁻ (11)

Electrolyzed water is water which is produced by an electrolysis reaction. Although efficacy is different between the reduction side and the oxidation side, the electrolyzed water has a healthful effect, a bactericidal effect, a detergent effect, and an effect of promoting the growth of farm products. It is possible to use it as drinking water, water for food preparation, cleaning water, agricultural water, and the like. Although the electrolysis reaction is promoted when water includes an electrolyte, however, in some cases, the electrolyte as a solute in water should to be removed. When a solid electrolyte is used as the electrolyte, it is unnecessary to remove the solid electrolyte from the water.

In many of the above-mentioned electrochemical systems such as fuel cells, electrolytic devices, and dehumidifiers, which have already been put to practical use, a perfluorosulfonic acid membrane sold under the tradename Nafion by DuPont is employed as a solid electrolyte. Also, the applicant of the present application has already provided solid electrolytes comprising an inorganic/organic hybrid compound of a zirconic acid compound and polyvinyl alcohol (refer to Japanese Unexamined Patent Publication (Kokai) No. 2003-242832; and Japanese Unexamined Patent Publication (Kokai) No. 2004-146208). Furthermore, for these solid electrolytes, a casting method, which is a method for forming membranes by casting an aqueous raw material solution on a flat plate and removing the water of the solvent by heating, is applied.(refer to Japanese Unexamined Patent Publication (Kokai) No. 2004-285458).

### SUMMARY OF THE INVENTION

However, the above-mentioned perfluorosulfonic acid electrolyte membranes have a problem of being costly mainly due to the complexity of the manufacturing process. Furthermore, there is the drawback that reducing the cost of the entire system is difficult since materials that can be used for electrodes and other parts constituting the system are limited to acid-resistant materials, such as noble metals as a result of the electrolyte membranes being strongly acidic. Also, there is the problem that in some applications, such as primary batteries, secondary batteries, and the like, since the electrode active material cannot exist stably or does not function if it is not in alkali, an acidic solid electrolyte cannot be used.

In contrast, the solid electrolyte comprising an inorganic/organic hybrid compound of a zirconic acid compound and polyvinyl alcohol provided by the applicant of the present application is relatively inexpensive and operates even in an alkaline form. This hybrid compound can be prepared by neutralizing a zirconium salt or an oxyzirconium salt coexisting in a solution with polyvinyl alcohol by alkali and shows comparatively high proton or hydroxide ion conductivity by impregnating with alkali such as sodium hydroxide, sodium silicate, or sodium carbonate.

However, when a solid electrolyte of the inorganic/organic hybrid compound comprising a zirconic acid compound and polyvinyl alcohol is manufactured, there is the problem that the raw material solution immediately gels if the conditions are not appropriate, since it is easy for the phenomenon of agglomeration and gelation of the raw material solution to occur in the neutralization step. In most cases, although the solid electrolyte is used in the membrane form, it is difficult for the raw material solution to be formed into a membrane once gelation occurs. In other words, it is difficult to cast a gelled raw material solution homogeneously on a flat plate and, even if a film can be formed, the strength thereof is weak since it is not homogeneous.

On the other hand, from a practical perspective, it is desirable to reduce the energy cost and the manufacture time by making the concentration of the polyvinyl alcohol, or the zirconium salt or the oxyzirconium salt included in the raw material solution as high as possible and reducing the amount of water to remove when making the membrane. Also, in order to manufacture the membrane by a casting method, it is beneficial to increase the viscosity of the raw material solution to a certain degree for formability and, also from this aspect, it is beneficial to increase the concentration of the raw material solution, in particular, the concentration of the polyvinyl alcohol. However, there is a problem that with increasing the concentration of the polyvinyl alcohol, or the zirconium salt or the oxyzirconium salt, the gelation of the raw material solution of this solid electrolyte becomes easier to occur and thus, it is difficult to adjust the concentration to the desired concentration during membrane manufacturing. In particular, the polyvinyl alcohol concentration is influential and it is difficult to increase the polyvinyl alcohol concentration to a level to obtain sufficient viscosity for membrane manufacture.

The present invention solves the above-mentioned problems of ion-conducting solid electrolytes and an object thereof is to provide a method for manufacturing a solid electrolyte with high ion-conductivity comprising a hybrid compound of polyvinyl alcohol and a zirconic acid compound which can prohibit gelation of the raw material solution with keeping the concentration of the raw material solution of the solid electrolyte desirable for efficient manufacture of membranes, and provides the solid electrolyte which is cheap, and even functions in an alkaline form.

In order to fulfill the above-mentioned object, the present invention provides a method for manufacturing a solid electrolyte with high ion-conductivity comprising a hybrid compound which contains at least polyvinyl alcohol and a zirconic acid compound as constituents. The method comprises the steps of hydrolyzing a zirconium salt or an oxyzirconium salt in a solution comprising a solvent including water, the polyvinyl alcohol, and the zirconium salt or the oxyzirconium salt, removing the solvent, and contacting with alkali. The hydrolysis may be carried out by heating to 50° C. or higher or by heating to 50° C. or higher at a pH of 7 or less.

According to the present invention, by heating the solution in which a solvent including water, polyvinyl alcohol, and a zirconium salt or a oxyzirconium salt coexist, to 50° C. or higher, the zirconium salt or the oxyzirconium salt are hydrolyzed and condensation polymerization of the generated zirconic acid compound simultaneously occurs. At the condensation polymerization reaction of this zirconium acid compound, entanglement of the zirconium acid compound with the coexistent polyvinyl alcohol molecules occurs at a molecular level and both bond by hydrogen bonding or dehydration condensation via a hydroxyl group to form the hybrid compound. Also, by carrying out the hybridizing reaction at a pH of 7 or less, it is difficult for a gelling reaction of the resulting hybrid compound solution to occur.

Furthermore, when the solvent is removed from the resulting hybrid compound solution, a solid electrolyte comprising the hybrid compound is formed. At this time, although hydrolysis of the zirconium salt or the oxyzirconium salt, or dehydration condensation of the zirconic acid compound is not necessarily completed, hydrolysis or dehydration condensation further proceeds and a stable hybrid compound in an alkaline form is completed by contacting the hybrid compound with alkali.

In the case of conventional examples in Japanese Unexamined Patent Publication (Kokai) No. 2003-242832; and Japanese Unexamined Patent Publication (Kokai) No. 2004-146208, although neutralization is carried out by alkali in a solution state, only the pH of the part contacted with alkali increases to more than 7, hydrolysis or dehydration condensation occur, and gelation occurs since the reaction of only the part contacted with the alkali is completed at once. Since this reaction is irreversible, the gelled part does not return to the initial liquid state. In contrast, when hydrolysis or dehydration condensation is carried out by heating with maintaining the pH of the solution at 7 or less like the present invention, it is difficult for gelation to occur since the reaction proceeds homogeneously for the entire raw material solution and it is possible to stop the reaction in an incomplete state. When the reaction is completed by alkali in the step thereafter, the gelation problem does not occur since a solid product is already formed.

### BRIEF DESCRIPTION OF THE DRAWINGS

FIG. 1 is a system diagram schematically showing the manufacturing steps of the solid electrolyte with high ion-conductivity according to the present invention.

### DETAILED DESCRIPTION OF THE INVENTION

The best mode for carrying out the manufacturing method of a solid electrolyte with high ion-conductivity according to the present invention is explained in detail below based on the drawing. The solid electrolyte with high ion-conductivity of the present invention is obtained by forming a hybrid compound comprising at least polyvinyl alcohol and a zirconic acid compound as constituents and then contacting the hybrid compound with alkali. This solid electrolyte with high ion-conductivity comprises a hybrid compound which contains at least polyvinyl alcohol and a zirconic acid compound as constituents and which is obtained by hydrolyzing a zirconium salt or an oxyzirconium salt by heating a solution comprising a solvent including water, the polyvinyl alcohol, and the zirconium salt or the oxyzirconium salt to 50° C. or higher at a pH of 7 or less; then removing the solvent; and then contacting with alkali.

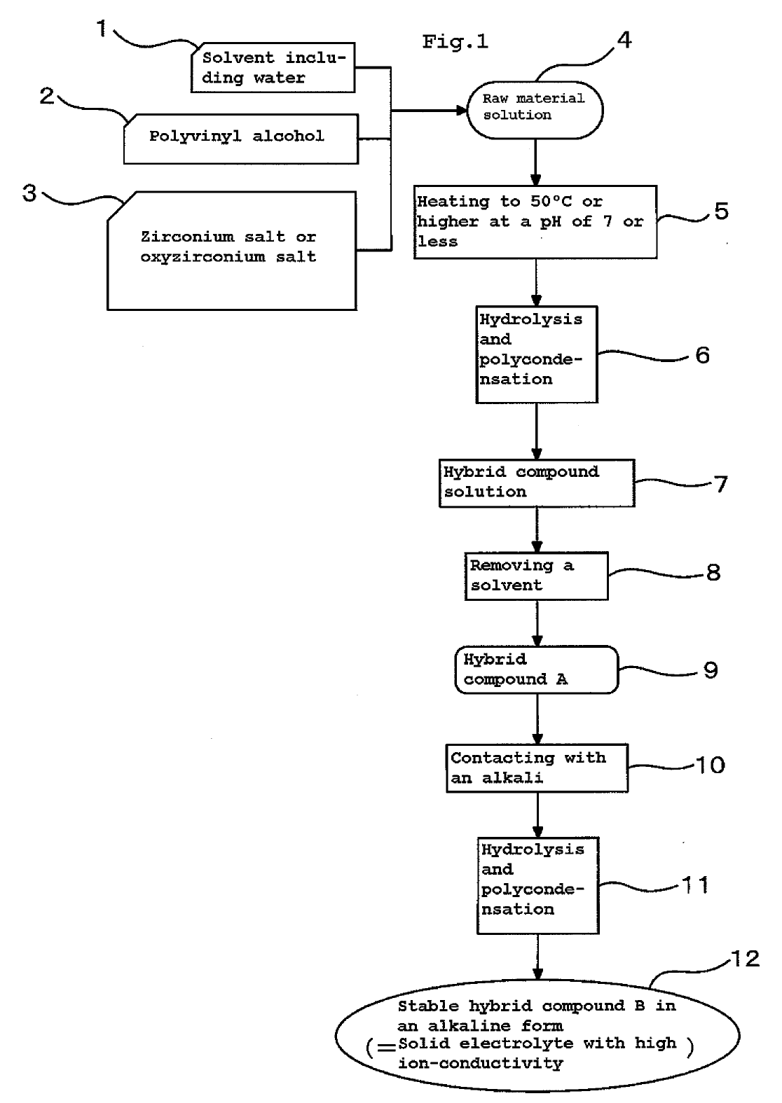

FIG. 1 is a system diagram schematically showing the manufacturing steps of the solid electrolyte with high ion-conductivity according to the present invention. Firstly, as raw materials, a solvent including water is prepared in step 1, polyvinyl alcohol is prepared in step 2, and a zirconium salt or an oxyzirconium salt is prepared is step 3. These raw materials are mixed in step 4 and a raw material solution is obtained where the polyvinyl alcohol and the zirconium salt or the oxyzirconium salt coexist in the solvent including water. In order to efficiently carry out membrane manufacture of the solid electrolyte by removing water in the raw material solution within the actual time range of production, it is preferable that the concentration of the polyvinyl alcohol in the raw material solution is 5% by weight or more, and more preferably 10% by weight or more. Any type of zirconium salt or oxyzirconium salt may be used as long as it dissolves in the solvent including water. Any values can be used for the oxygen and the anion proportions, and the water content.

Also, since the reaction of the present invention proceeds in a solvent including water, there is no need for the solvent to be only pure water as long as it includes water. However, considering the solubility of the zirconium salt or the oxyzirconium salt, or the solubility of the polyvinyl alcohol, water is the most preferred solvent. Thus, the solvent including water as a constituent element of the present invention shown in step 1 may be any solvent as long as it includes water and can coexist with water. In more detail, since the reaction of the present invention occurs even with the other solvents coexisting as long as there is the minimum amount of water useful for the reaction, there are many solvents that can coexist with water and these may be present with water as the solvent of the present invention. In other words, the solvent means all of the components in the raw material solution other than the polyvinyl alcohol and the zirconium salt, which are solutes. For example, sugar will become a member of the solvent if it is dissolved, that is, all of the substances deemed to be liquids (includes dissolved solids) that can substantially coexist with water can become the solvent.

Also, it is not necessary for the above-mentioned polyvinyl alcohol to be purified polyvinyl alcohol and can be used as long as it substantially functions as polyvinyl alcohol. For example, even polyvinyl alcohol where a part of the hydroxyl groups is replaced by another group and polyvinyl alcohol where other polymers are copolymerized with a part thereof can function as the polyvinyl alcohol. Also, polyvinyl acetate, which is a raw material of polyvinyl alcohol, can be used as a starting material since a similar effect can be achieved if polyvinyl alcohol is generated in the reaction process of the present invention.

If within the scope for which there is sufficient manifestation of the polyvinyl alcohol function in the present invention, other polymers, for example, polyolefin polymers such as polyethylene and polypropylene, polyacrylic polymers, polyether polymers such as polyethyleneoxide, and polypropyleneoxide, polyester polymers such as polyethylene terephthalate and polybutylene terephthalate, fluorine polymers such as polytetrafluoroethylene and polyvinylidene fluoride, glycopolymers such as methylcellulose, polyvinyl acetate polymers, polystyrene polymers, polycarbonate polymers, epoxy resin polymers or other organic and inorganic additives may be mixed.

Next, in step 5, the raw material solution is heated to 50° C. or higher while maintaining the pH at 7 or less. By doing so, as shown in step 6, the zirconium salt or the oxyzirconium salt is hydrolyzed and condensation polymerization of the zirconic acid compound simultaneously occurs. At the time of the condensation polymerization reaction of this zirconic acid, entanglement of the polyvinyl alcohol molecules coexistent in the raw material solution and the zirconic acid compound molecules occurs at a molecular level, and both bond by hydrogen bonding via a hydroxyl group or dehydration condensation to form the solution of the hybrid compound shown in step 7. When the pH of the raw material solution exceeds 7, hydrolysis of the zirconium salt and the following condensation reaction of the zirconic acid rapidly proceed, and when the concentration of the polyvinyl alcohol is high, gelation proceeds. Thus, the pH of the raw material solution is 7 or less, and preferably 2 or less.

When the heating temperature is lower than 50° C., it is difficult for sufficient hydrolysis of the zirconium salt to occur in the actual time range of production. In contrast, when the heating temperature is extremely high, there is the problem that gelation begins since hydrolysis of the zirconium salt and the following condensation reaction of the zirconic acid proceeds excessively. In such a situation, however, there are no particular limitations to the maximum temperature since it is possible to control by adjusting the heating time. Nevertheless, from the perspective of the necessity of keeping the temperature of the raw material solution homogeneous at increasing and decreasing the temperature, a temperature range until about 80° C. is preferable from a practical point of view.

Although the heating time may be adjusted according to the selected heating temperature, a range from 20 minutes to 5 hours is appropriate at 50° C. If less than this, the progress of the hydrolysis of the zirconium salt is not sufficient and if longer than this, there is a possibility that gelation begins. Also, a range from several minutes to about 30 minutes is preferable at 80° C.

Although zirconic acid means a compound having ZrO₂ as the basic unit, which includes H₂O, and is represented by the general formula ZrO₂.xH₂O, zirconic acid compounds of the present invention includes the entirety of zirconic acid and derivatives thereof, as well as compounds having zirconic acid as the main constituent. As long as the properties of zirconic acid are not impaired, other elements may be substituted in a part, and shift from the stoichometric composition and the addition of additives is allowed. For example, zirconates and zirconium hydroxides also have the basic unit ZrO₂, and derivatives based on these as well as compounds having these as the main constituent are included in the zirconic acid compound.

At this time, since the hybridizing reaction shown in step 6 is carried out while maintaining the pH at 7 or less, gelation is very difficult to occur since the reaction proceeds homogeneously for the entire raw material solution and it is possible to stop the reaction before it is completed.

In step 8, when the solvent is removed from the hybrid compound solution obtained in step 7, a hybrid compound A, which becomes the solid electrolyte shown in step 9 is formed. With respect to the hybrid compound A, the hydrolysis of the zirconium salt or the oxyzirconium salt, or the dehydration condensation of the zirconic acid compound proceeds not necessarily perfectly. If a solid electrolyte is made by membrane formation without contacting the complex compound A with alkali, only an imperfect solid electrolyte is obtained and holes are generates in it when it is immersed in water. Thus, the hybrid compound A of step 9 obtained by solidification in step 8 by removing the solvent from the hybrid compound solution made in step 7 is contacted with alkali in step 10.

The alkali which contacts the complex compound A may be any alkali as long as it can neutralize the zirconium salt or the oxyzirconium salt. It is possible to use ammonia, sodium hydroxide, potassium hydroxide, lithium hydroxide, calcium hydroxide, strontium hydroxide, barium hydroxide, and carbonates. These may be used alone or multiple alkalis may be mixed and used. Also, as a method for contacting the formed hybrid compound A with the alkali, there are methods such as immersing in an alkaline solution, smearing or spraying the complex compound with an alkaline solution, and exposing to an alkaline vapor.

By contacting with alkali in this way, hydrolysis and dehydration condensation of the hybrid compound A is further promoted in step 11 and a stable hybrid compound B in an alkaline form (=solid electrolyte with high ion-conductive according to the present invention) is obtained in step 12. When contacting with alkali, the problem of gelation does not occur since the complex compound B has already been formed as a solid. The present invention is not limited to these Examples.

### EXAMPLES

The method for manufacturing a solid electrolyte with high ion-conductivity according to present invention is further explained in detail below by examples.

### Example 1

To manufacture the solid electrolyte according to the present invention, firstly, 3 g of zirconium oxychloride octahydrates (ZrCl₂O.8H₂O) was dissolved in 50 cc of a 10% by weight aqueous solution of polyvinyl alcohol having a degree of polymerization of 3,100 to 3,900 and a degree of saponification of 86 to 90% to prepare a raw material solution. A hybrid compound solution was prepared by heating for 1 hour so as to make the solution 50° C. while stirring this raw material solution. At this time, it was found that the pH was 1 on examination of the raw material solution by pH test paper. No gelation of the thus prepared hybrid compound solution occurred and although a little viscous, a hybrid compound solution had sufficient fluidity.

Next, a polyester film was put on a flat and smooth pedestal of a coating device (K Control Coater 202 manufactured by P K Print Coat Instruments Ltd.) equipped with a blade that allowed adjustment of the gap with the pedestal using a micrometer. The defoaming-treated hybrid compound solution was cast over the polyester film. At this time, the pedestal was controlled at 50° C. by heating. Immediately after casting the hybrid compound solution over the pedestal, the blade with the gap adjusted to 0.6 mm was swept over the hybrid compound solution with a constant speed to make it into a constant thickness. The hybrid compound solution was kept heated at 50 to 60° C. and removing water, and after its fluidity was nearly lost, the same hybrid compound solution was cast again over it and immediately the blade with the gap adjusted to 0.6 mm was swept again over the hybrid compound solution to make it a constant thickness. After a solidified hybrid compound A in the membrane form was obtained by removing the water, the temperature of pedestal was raised to 110 to 120° C. and heating was continued for one and a half hours while keeping this state. Subsequently, the membrane formed on the pedestal was peeled off, and after being contacted with alkali by immersing in a 1.7% by weight ammonia aqueous solution for 2 hours at room temperature, was washed with hot water to obtain a hybrid compound B (solid electrolyte).

### Example 2

A raw material solution was prepared by dissolving 3 g of zirconium oxychloride octahydrates (ZrCl₂O.8H₂O) in 50 cc of a 10% by weight aqueous solution of the same polyvinyl alcohol as Example 1. At this time, heat treatment was not carried out on the raw material solution. Similar to Example 1, this raw material solution was cast on the pedestal of a coating device and the pedestal was controlled at 50° C. by heating. At this time, it was found that the pH was 1 on examination of the raw material solution by pH test paper. In this step, the oxyzirconium salt in the raw material solution causes a hydrolysis reaction to occur on the pedestal by this heating and a dehydration condensation reaction of the generated zirconic acid occurs. After that, a membrane was formed by the same processes as in Example 1 and after being immersed in 1.7% by weight ammonia aqueous solution at room temperature for 2 hours, was washed in hot water. In Example 1, the raw material solution in which the polyvinyl alcohol and the oxyzirconium salt coexist is heated on the pedestal of the coating device at membrane formation and since hydrolysis also occurs at this time, it is not always necessary to heat the raw material solution before membrane formation. Example 2 presents an example which omits the heating of the raw material solution before membrane formation in Example 1.

### Comparative Example 1

A solid electrolyte was prepared by washing the hybrid compound A obtained in Example 1 in hot water at about 60° C. without immersing in ammonia.

### Comparative Example 2

A raw material solution was prepared by dissolving 3 g of zirconium oxychloride octahydrates (ZrCl₂O.8H₂O) in 50 cc of a 10% by weight aqueous solution of the same polyvinyl alcohol as Example 1. While this raw material solution was stirred with a magnetic stirrer, 1.7% by weight ammonia aqueous solution was added thereto by dropping, neutralizing the raw material solution. However, just after starting the dropping of the ammonia solution, since gelation occurred and a jelly-like agglomerate was generated, formation of a membrane by the following casting process was not possible.

### Comparative Example 3

A raw material solution was prepared by dissolving 3 g of zirconium oxychloride octahydrates (ZrCl₂O.8H₂O) in 125 cc of a 4% by weight aqueous solution of polyvinyl alcohol. While this raw material solution was stirred with a magnetic stirrer, 1.7% by weight ammonia aqueous solution was added thereto by dropping, neutralizing the raw material solution. Similar to Comparative Example 2, although gelation of the solution occurred just after the start of dropping the ammonia aqueous solution, since the generated gel was soft and able to be broken up by the stirring, a membrane could be formed by the same method as Example 1 or Example 2.

With respect to Example 1 in which the solid electrolyte membrane is immersed in ammonia solution in the final step, the solid electrolyte membrane that had a smooth surface, had high transparency, and was very homogeneous was obtained without generating holes in the membrane at the process of washing in hot water. Also, with respect to Example 2 in which the heating of the raw material solution before membrane formation was omitted, the solid electrolyte membrane was almost the same as that in Example 1, except for a little lack of a surface smoothness. In contrast, with respect to Comparative Example 1 in which the solid electrolyte membrane was not immersed in ammonia solution, although the membrane shape was maintained at the process of washing in hot water, there were holes in places in the film since hydrolysis of the oxyzirconium salt and the dehydration condensation reaction of the zirconic acid compound were not sufficiently completed.

Also, in Comparative Example 2, on examination by pH test paper of the gelled part of the raw material solution generated by the dropping of ammonia solution, the pH was 8 or more, although there was a little difference depending on the place. Furthermore, although a membrane was formed in Comparative Example 3, the membrane was more fragile than the membranes prepared in Examples 1 and 2 since the finally obtained solid electrolyte membrane was not homogeneous by the influence of the generation of a gel and the strength when water is absorbed is remarkably weak.

In the cases of the above-mentioned Examples 1 and 2, and Comparative Examples 1, 2, and 3, the polyvinyl alcohol and the oxyzirconium salt are in a mixed state at a molecular level in a dissolved state. In conventional methods, as shown in Comparative Examples 2 and 3, alkali is added in this state, the pH of the part contacting with alkali increase to 8 or more, hydrolysis of the oxyzirconium salt and the generation and the condensation polymerization of the zirconic acid compound following this rapidly occur, entanglement at a molecular level of the polymerized zirconic acid compound with the coexistent polyvinyl alcohol and hybridization quickly proceed. Firstly, since the reaction is completed at once at only the part contacting with alkali, only this part is strongly combined and gelation occurs. Thus, by the conventional methods, when the concentration of the polyvinyl alcohol in the raw material solution is high, since this entanglement and hybridization is excessively fast, gelation of the raw material solution becomes easier to occur and it causes a problem that following molding is difficult. Like Comparative Example 3, when the concentration of the polyvinyl alcohol is comparatively low, although the gelation problem is reduced, the problem that the strength of the obtained membrane is low remains. As disclosed in Japanese Unexamined Patent Publication (Kokai) No. 2003-242832 and Japanese Unexamined Patent Publication (Kokai) No. 2004-146208, although the gelation problem does not occur in the conventional methods as long as the concentration of the polyvinyl alcohol is, for example, about as low as 2% by weight. However, it is not practical to make the concentration of the raw material solution too low, because the viscosity for the membrane formation by the casting method is insufficient and much energy cost and time is needed to remove the solvent.

In contrast, since the alkali operates on an already solidified compound in the present invention shown in Examples 1 and 2, problems in the conventional methods such as gelation do not occur. However, if the membrane is formed in Examples 1 and 2 without sufficiently heating the raw material solution in which the oxyzirconium salt and the polyvinyl alcohol coexist, the obtained membrane is simply a mixture of an water-soluble oxyzirconium salt and an water-soluble polyvinyl alcohol, and dissolves in water. Thus, when treated with an alkali aqueous solution, the film is deformed or is torn. However, like the present invention disclosed in Examples 1 and 2, during the membrane making or before that, if heating is carried out at 50° C. or higher in the state where the oxyzirconium salt and the polyvinyl alcohol coexist, since the hydrolysis reaction of the oxyzirconium salt and the condensation reaction of the zirconic acid compound proceed to a certain extent, and hybridizing with the polyvinyl alcohol occurs, there is no deterioration of the membrane at the alkali treatment. As long as an alkali is not added to the solution and the pH is not raised to 8 or more, the occurrence of gelation is difficult to occur since the hydrolysis reaction of the oxyzirconium salt and the condensation reaction of the zirconic acid compound by heating homogeneously proceed in the raw material solution and do not progress to the complete level.

In the state of the oxyzirconium salt and the polyvinyl alcohol coexisting, since hybridization does not sufficiently progress only by heating to 50° C. or higher with maintaining a pH at 7 or less, only imperfect membranes with holes generated by immersing in water can be obtained as shown in Comparative Example 1, if the operation of contacting with alkali is not carried out after membrane formation. Thus, contacting with alkali is beneficial after removing the solvent from the raw material solution and solidifying the solid electrolyte.

As disclosed above, the solid electrolyte with high ion-conductivity according to the present invention is proton conductive or hydroxide conductive. So, as in the case of conventional perfluoro sulfonic acid ion-exchange membranes, it can be used in fuel cells, steam pumps, dehumidifiers, air conditioners, electrochromic devices, electrolytic devices, electrolytic hydrogen-producing devices, electrolytic hydrogen peroxide-producing apparatus, electrolyzed water-producing devices, humidity sensors, and hydrogen sensors. Since this solid electrolyte material shows high ion conductivity even in an alkaline form, it can be applied to primary batteries, secondary batteries, optical switch systems, and battery systems using a multivalent metal.

As explained in detail above, according to the present invention, a solid electrolyte with high ion-conductivity comprising a hybrid compound of a zirconic acid compound and polyvinyl alcohol can be obtained which can prevent gelation of the raw material solution with keeping the raw material solution concentration of the solid electrolyte desirable for efficient manufacture of membranes, which can simultaneously solve the conflicting problems of keeping concentration desirable and preventing gelation, and furthermore, provides the solid electrolyte which is cheap and functions even in an alkaline form.

What is claimed is:

1. A method for manufacturing a solid electrolyte with high ion-conductivity comprising a hybrid compound which contains at least polyvinyl alcohol and a zirconic acid compound as constituents, comprising the steps of hydrolyzing a zirconium salt or an oxyzirconium salt in a solution comprising a solvent including water, polyvinyl alcohol, and the zirconium salt or the oxyzirconium salt, removing the solvent, and contacting with alkali.

2. A method for manufacturing a solid electrolyte with high ion-conductivity comprising a hybrid compound which contains at least polyvinyl alcohol and a zirconic acid compound as constituents, comprising the steps of hydrolyzing a zirconium salt or an oxyzirconium salt by heating a solution comprising a solvent including water, polyvinyl alcohol, and the zirconium salt or the oxyzirconium salt to 50° C. or higher, removing the solvent; and contacting with alkali.

3. A method for manufacturing a high ion-conducting solid electrolyte with high ion-conductivity comprising a hybrid compound which contains at least polyvinyl alcohol and a zirconic acid compound as constituents, comprising the steps of hydrolyzing a zirconium salt or an oxyzirconium salt by heating a solution comprising a solvent including water, polyvinyl alcohol, and the zirconium salt or the oxyzirconium salt to 50° C. or higher at a pH of 7 or less, removing the solvent, and contacting with an alkali.
